(19) United States
(12) Patent Application Publication
(10) Pub. No.: US 2013/0006689 A1
(43) Pub. Date: Jan. 3, 2013

(54) METHODS, SOFTWARE, AND SYSTEMS FOR MAINTAINING A SINGLE HIERARCHY OF TASKS ACROSS MULTIPLE PROJECTS AND/OR MULTIPLE TASK MANAGEMENT TOOLS

(75) Inventors: Alec Kinnear, Bratislava (SK); Peter Baran, Bratislava (SK); Zdenka Uhrikova, Bratislava (SK)

(73) Assignee: FOLIOVISION S.R.O., Bratislava (SK)

(21) Appl. No.: 13/171,809

(22) Filed: Jun. 29, 2011

(51) Int. Cl. G06Q 10/00

(52) U.S. Cl. 705/7.16; 705/7.12

(57) ABSTRACT

Schemes providing master list functionality that allows a user to reorder to-do items from across multiple projects and/or multiple project management tools. Such schemes can ensure that whatever project management tools the user and others associated with the various projects are using at any time, changes in their task planning will be reflected both in the master list and across all other projects and project management tools, as needed. The necessary hierarchy is maintained by creating an absolute order between different projects and reflecting changes in task order in both directions.

### FIELD OF THE INVENTION

The present invention generally relates to the field of information systems. In particular, the present invention is directed to methods, software, and systems for maintaining a single hierarchy of tasks across multiple projects and/or multiple task management tools.

### BACKGROUND

Nowadays people tend to work on many projects at the same time. Managers managing a number of people covering several projects and employees have often more than one project to take care of at a time. Each project has multiple tasks (a.k.a. “to-dos”) that need to be done by several people. Organizing the workload is therefore crucial for successfully finishing the project. In order to accomplish this, to-do lists are being formed for each project. With multiple projects and multiple to-do lists in a project, it is hard for the people to organize their time and to not miss an important task.

Project management tools are therefore being used in which different projects and to-do lists can be formed. A number of project management tools are available at the moment, either running locally within a company or, alternatively, online via access through the Internet. Users are generally allowed to create new to-do lists and to-dos, and to assign to-dos to the responsible people. Usually within the project or a to-do list it is possible to reorder the items. This is often done by priority code and sometimes by drag and drop in a graphical user interface

### SUMMARY OF THE DISCLOSURE

In one implementation, the present disclosure is directed to a method of assisting a user in managing to-do items across a plurality of to-do task lists each containing at least one to-do item. The method includes: displaying to-do items from differing ones of the plurality of to-do task lists in an electronically displayed to-be-ordered list; receiving add-to-master-list input from the user to move ones of the to-do items into an electronically displayed master-list; in response to said receiving add-to-master-list input, moving to-do items into the electronically displayed master list so that the plurality of to-do items are displayed in a user-desired order; and assigning, within a database, a global order to the plurality of to-do items as a function of the locations of the plurality of to-do items within the electronically displayed master list.

In another implementation, the present disclosure is directed to a machine-readable storage medium containing machine-executable instructions for performing a method of assisting a user in managing to-do items across a plurality of to-do task lists each containing at least one to-do item. The machine-executable instructions include: a first set of machine-executable instructions for displaying to-do items from differing ones of the plurality of to-do task lists in an electronically displayed to-be-ordered list; a second set of machine-executable instructions for receiving add-to-master-list input from the user to move ones of the to-do items into an electronically displayed master-list; a third set of machine-executable instructions for moving, in response to the receiving of add-to-master-list input, to-do items into the electronically displayed master list so that the plurality of to-do items are displayed in a user-desired order; and a fourth set of machine-executable instructions for assigning, within a database, a global order to the plurality of to-do items as a function of the locations of the plurality of to-do items within the electronically displayed master list.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a diagrammatic representation of a conventional project management tool containing projects, to-do lists, and a hierarchy of tasks;

FIG. 2 is a schematic diagram of a computer system embodying master-list features of the present invention;

FIG. 3 is a diagram illustrating a master list of the present disclosure assembled from tasks across multiple to-do lists;

FIG. 4 is a diagram depicting an example of reordering tasks within a global ordering scheme within the master list of FIG. 3;

FIG. 5 is a diagram illustrating an example of a relationship between the reordering of tasks in the master list of FIG. 3 and the task positions within the related to-do lists, wherein there is no reordering of tasks within the related to-do lists;

FIG. 6 is a diagram illustrating another example of a relationship between the reordering of tasks in the master list of FIG. 3 and the task positions within the related to-do lists, wherein there is reordering of tasks within one of the related to-do lists;

FIG. 7 is a diagram illustrating a further example of a relationship between the reordering of tasks in the master list of FIG. 3 and the task positions within the related to-do lists, wherein there is reordering of tasks within one of the related to-do lists;

FIG. 8 is a diagram illustrating the adding of a new task in the global order within the master list of FIG. 3;

FIG. 9 is a diagram depicting an initial checkout of tasks from the original project management tool into the master list of FIG. 3;

FIG. 10 is a diagram illustrating the principle of contexts in the scenario of FIG. 3;

FIG. 11 is a diagram illustrating an example of the reordering of tasks within one of the contexts of FIG. 10 and the effect of the reordering on the master list;

FIG. 12 is a diagram illustrating an example of the reordering of tasks within the context of FIG. 11 and the effect of the reordering on the master list and other contexts;

FIG. 13 is flow diagram illustrating an example of how changes in task order within a master list can be distributed back to an original project management tool;

FIG. 14 is a flow diagram illustrating an example of how a master list application of the present disclosure can be updated after changes in the original project management tool;

FIG. 15 is a schematic diagram illustrating an example of how a user can access a master list application of the present disclosure remotely;

FIG. 16 is a schematic diagram illustrating an example of how a user can access a master list application of the present disclosure from a local network;

FIG. 17 is a high-level schematic diagram of an exemplary software-driven machine capable of implementing systems and methods of the present invention; and

FIG. 18 is a schematic diagram of the user interface of an exemplary master-list application.

### DETAILED DESCRIPTION

### Overview

The present inventor has recognized that what is missing from project management tools (or more generally, task management tools) is software that allows a user to pull tasks together from multiple projects/task lists and one or more task management tools across an entire system, whether the software is provided in a software as a service (SaaS) environment or in a local-application environment, or both, into a single manageable list, referred to in this disclosure as a “master list.” Disclosed herein are methods, systems, and software that offer solutions for maintaining a list of all tasks, or to-dos, across all projects and to-do lists organized in one master list, wherein the order of single to-dos can be changed as needed at the direction of a user, such as a manager, supervisor, business owner, or anyone having the position and authority, to direct workflow and execution of task across the multiple projects and task executers. A system made in accordance with the present disclosure allows users to see all to-dos in the global order so that it is easy for them to spot the most important tasks and change their priorities anytime.

As alluded to above, master-list software of the present disclosure can merge together not only tasks from different projects within a single project management tool, but also from different projects from across multiple project management tools. A goal is to have all tasks in one place, in one global order within a master list. Following is a general description of aspects and features of master list software, followed by a specific example of such software.

### Master List

A master list in the context of the present disclosure contains all tasks, or to-do items, that belong to a user across all projects and all to-do lists. Tasks are displayed in a single list, naming, for example, the project, to-do list, and the titles of the tasks on the master list. The order of tasks in the master list is defined by the user and saved as a global order. Each task has a unique position within the global order, while it also maintains the position within a corresponding to-do list(s) from one or more project management tools.

Convenient graphical-user-interface-based drag and drop operations can be implemented to allow a user to reorder the tasks in the master list and, so, arrange all tasks in the list according to their importance as determined by the user. An update mechanism ensures that the order of tasks is also changed in the corresponding to-do lists and in the original project management tool(s).

### Representation in a Database

All data may be stored in a master list database, wherein the main table contains details of all tasks from across the entire system. These details are collected from the original project management tool(s), and generally they typically contain a title of each task, the person responsible for each task, the due date of each task, the project and to-do list each task is filed under, a task identifier (ID) for each task from the corresponding original project management tool, and the order of each task within the to-do list in the corresponding original project management tool. For the purpose of the master list, a field of the table can be used for designating the global ordering of the tasks within the master list. In one example, each global order value can be either null or any positive integer number.

The order of the tasks in the master list can be set based on this global-order field. In one example, the tasks in the master list are sorted in ascending order based on the global order field values for the various tasks. In this example, tasks with order equal to null have not yet been assigned to the master list, and they are in a queue waiting for a user to decide about their importance relative to other tasks.

Additional tables can be designed to maintain projects, to-do lists, and users in the relational structure for the database query optimization. Following are examples of various tables that can be used in conjunction with implementing master-list functionality of the present disclosure.
A projects table designed and configured to contain, for example, an ID of each project from the corresponding original project management tool, the title of each project, an ID of the company each project belongs to, and a color used for highlighting within the master list to aid the user in readily identifying the project to which each particular task belongs.
A to-do list table designed and configured to contain, for example, a task ID from the original project management tool, the title of the to-do list, an ID of the project to which each task belongs, a count of completed tasks, a count of uncompleted tasks, a flag for each private task, and the position of each task within the master list.
A companies table designed and configured to contain, for example, an ID for each company from the corresponding original project management tool, the name of each company, and a new ID within the master-list system to avoid any conflicts, particularly from across multiple project management tools.
A users table designed and configured to contain, for example, an ID for each user from the corresponding original project management tool, login information for each user, the name of each user, an ID for each user's master list within the master-list system, and an ID of the company to which each user belongs.
A user-capability table designed and configured to contain, for example, the capability of each user from the corresponding original project management tool (e.g., user, admin, etc.).
A users-context table designed and configured to contain all contexts for each user, along with their names and task counts.
Relational tables designed and configured to maintain, for example, relations of: companies to projects; companies to users; users to projects; projects to to-do lists; to-do lists to to-dos; and to-dos to master list.

### Assigning Global Order

Typically, when a user creates a new task, either in the master-list software or in an original project management tool, no global order is assigned to it. The new task may be queued in the master-list software and waits for that user or another user to decide where the new task belongs in the global order within the master list.

When a user logs into the master-list software for the first time, typically all tasks are queued without having any global order assignments. The user has to decide about the priority of those tasks, and, by simple drag and drop operations fill them into the master list in the desired order. While assigning the global order, tasks may be reordered within their to-do lists, depending on the ordering the user applies in the master list.

### Contexts

Master-list software of the present disclosure can also be configured to enable a user to create subgroups of projects and to-do lists called “contexts”. Contexts are suitable for displaying just certain subgroups of all to-do lists, for example those having some similar features or to-do lists related to certain activity. As an example, say that there are number of projects and each project contains a to-do list titled “Call survey” with tasks needed to be done to make the call survey. One context can then display all “Call survey” to-do lists from all projects, so that the person responsible for these surveys immediately see all tasks needed to be done to finish the surveys. Only tasks from selected to-do lists will be displayed within a particular context. All other tasks from the master list will not be shown in that context and are referred to as tasks that are “invisible” within this context.

### Reordering Tasks

An exemplary algorithm for maintaining the order of tasks is strictly based on a concept of visibility within a context. When a task is reordered within a context, it is also reordered in the global order within the master list, but only according to its visibility within this context. The basic principle is that only one task can be reordered at the time. In one implementation, we define “affected tasks” as all tasks lying between the old and new positions of the reordered task in the list.

For example, assume the existence of Tasks 1, 2, 3, 4, 5 and that they are ordered accordingly in the master list. Then, if Task 3 is moved to the front, i.e., immediately before Task 1, then the following reordering applies: Task 3 is moved on the first position of the list, i.e., in place of Task 1; Task 1 is moved into the place of Task 2, and Task 2 in moved to the place where Task 3 used to be. Tasks 4 and 5 remain at their positions. The final order of the Tasks would be 3, 1, 2, 4, 5.

Now assume a context that shows only Tasks 1, 3, 5. Now the tasks will be reordered only according to the visibility in this context. Again we will move Task 3 in the front of Task 1. What happens in this context is that the Task 3 is moved to the first position in place of Task 1, and Task 1 is moved to the position of the next visible task, i.e., where Task 3 used to be. Consequently, after reordering, the order within this context would be 3, 1, 5. As far as the reordering is done only for visible tasks, the global order would then be 3, 2, 1, 4, 5. Notice that Task 2 remained at its original position, as this task was not visible within this context.

When a task shared across multiple contexts is reordered, the change is reflected to the other contexts in the same manner as they are reordered in the master list. Invisible tasks within the other contexts are left in their respective positions, switching positions only in the affected visible tasks within both contexts.

When reordering tasks in the master list, the change is reflected to all contexts in which the current reordered task is visible. If a task is moved above some other visible task(s) within the context, the positions are switched between the affected visible tasks.

In terms of previous definitions, all tasks belonging to other persons are invisible. Therefore, only positions of affected tasks belonging to the user are changed according the master list.

### Updates

In one embodiment, updates back to the original project management tool(s) are done on regular basis, not after every move to save the server load. When the new order is distributed back to the original tool(s), all changes made are checked against the order in the original tool. Care is taken that the relative order is maintained within all task lists. This means that when the reordering of tasks does not affect the order within its task list, no change is made. If the reordered task changed the order within its task list, the corresponding tasks are exchanged accordingly. This means that tasks belonging to different persons stay in their respective positions. When the reordering is done in the original project management tool, again, the relative changes between the tasks are transferred to the master list; only the order of selected tasks will be changed, thereby keeping the global order of all other tasks.

Restating this differently, when the order of tasks is changed in one context, the order is changed within the master list, all contexts, and back within the list in the original project management tool (where the application programming interface(s) (API(s)) and/or data access permit). Any change of order within an original project management tool is also mirrored in the master-list software according to the ordering algorithm outlined above in the subsection immediately above.

In this way, every effort of a user to organize the order of his/her tasks is respected across all contexts within the master list, all projects, and all project management tools, as appropriate. In one embodiment, the architecture of the master-list software is modular, allowing the inclusion of data from almost any project and/or task management tool. This allows the user to use almost any combination of task and project management software and yet maintain a unified order of tasks, thereby avoiding duplicating work while visualizing all tasks from all task lists and/or task management tools in a single place.

### Internal Representations

In one example of the master-list software, the tasks, users, and projects are stored in arrays, or tables, such as the tables described above in the Representation in a Database section. When a reordering is applied, old positions are rewritten by the new ones in these arrays. The update to the master-list database can be done on a regular basis, when all updates performed in the last few seconds are written into database tables at once.

Communication with the Original Application(s)

Communication with each original management tool can be done, for example, via an SaaS API or via custom-coded modules for local applications. In one embodiment, the master-list software fetches the remote data and brings it into its own database, creating a copy that can be stored either locally or remotely. As noted above, in one embodiment the updates back to the original project management tool(s) are done on regular basis as well, not after every action to save the server load.

### Local and Remote Access

In a presently preferred configuration, the master-list software is implemented as a server-based system, which means it can either run on a local server or it can be available online, such as in an SaaS context. When installed on a private company server, the master-list software can be accessible only through the local network. When installed on a “public” server, it can be accessed from anywhere where an Internet connection is available.

### Uses

Master-list functionality can be particularly useful to a user who works for two or more different clients with different project management applications. Another useful application of master-list functionality is for managers who can see the planned order of priority of work for each employee and correct the order of tasks directly when necessary or with a note suggesting changes (depends on company work etiquette). Those skilled in the art will be able to recognize other uses, as well.

### Privacy

In some embodiments, the master-list software is configured to maintain privacy at all times. Access to information is restricted to what items any user or manager can see. If a manager can see three out of six projects of an employee, that manager will see the tasks for only those three projects. This defines a natural context for the manager. Again, tasks that the manager cannot see are invisible within his natural context, so any changes to the order do not affect them, hence avoiding any conflicts.

### Conflicts in Task Order

In some embodiments, master-list software of the present disclosure resolves conflicts within an organization by near real-time sync of the different databases. In other embodiments, the master-list software is available in an offline version that allows syncing of local data with the Web data whenever a user has access to the Internet.

### Exemplary Embodiments

Master-list software of the present disclosure is suited for implementation in any suitable computer system, including a personal computer (laptop, desktop, tablet, etc.), a smart phone, a workstation-server environment, and cloud-computing environment, among others. As generally described above, master-list software of the present disclosure can provide a method and system for organizing tasks from multiple projects and to-do lists in one list called a “master list.” The master list allows one or more users to keep tasks from among multiple projects and/or project management tools in a global order, while still maintaining the order in single to-do lists. Embodiments of the presented invention engage server, network, and local sources to allow the user to connect to one or more project management applications from wherever the Internet is accessible. Exemplary embodiments are described below with reference to the accompanying drawings.

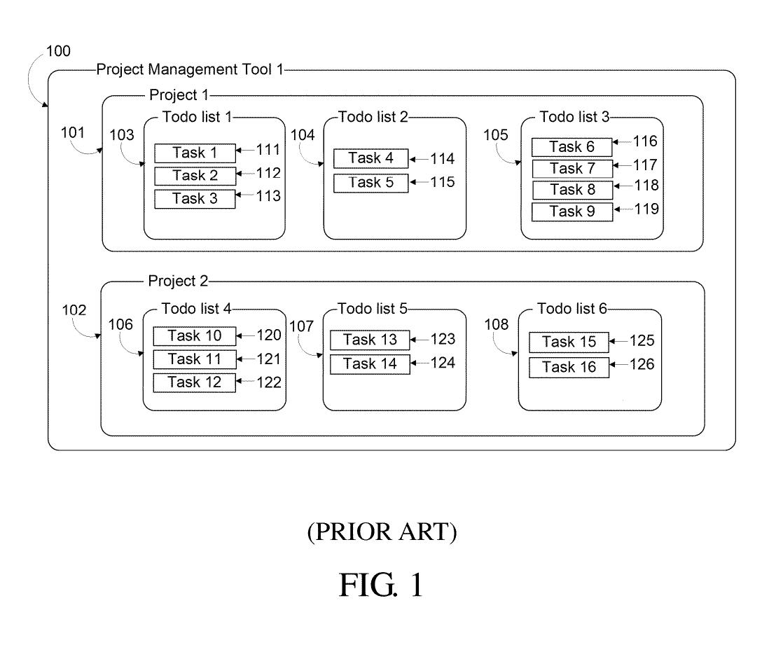

FIG. 1 illustrates a conventional setup from a project management tool 100 wherein several projects 101-102 are present. Multiple to-do lists 103 to 108 are assigned to each project (here, three to-do lists for each of two projects 101 and 102), each of them having several assigned tasks 111 to 126. The situation depicted in FIG. 1 is for one user, which means that a single user is responsible for all tasks 111 to 126.

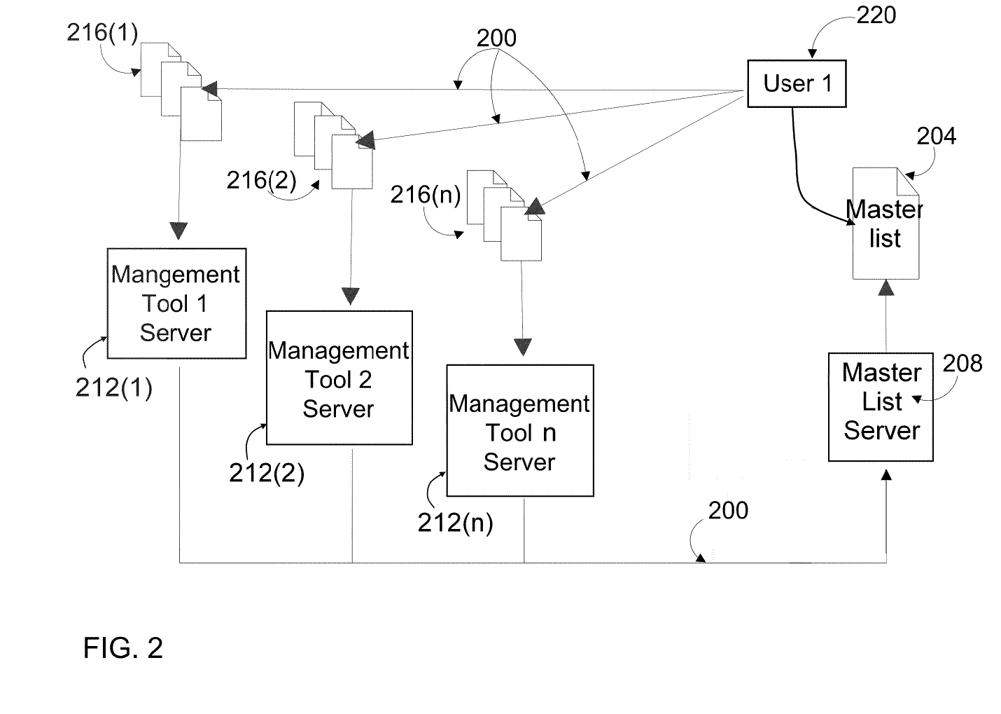

FIG. 2 represent basic communication channels, collectively represented by numeral 200, between master-list software (not shown) running on a master list server 208 (i.e., generic server hardware running the master-list software) and other project management tools 212(1) to 212(n) (212(1)-(n), for short). In this example, communication channels 200 between master list server 208 and project management tools 212(1)-(n) are implemented via either API or via custom-coded modules, depending on the particularities of the project management tool under consideration. Also in this example, user communication between master list server 208 and a user's computer 220 is implemented via a user channel 200, such as http protocol, and a user interface for the master-list software is displayed in a web browser on that user's computer. As those skilled in the art will readily appreciate, that user interface allows computer 220 to display, via its web browser, a master list 204 created by the master-list software running on master-list server 208. In this example, the user of computer 220 also has access directly to to-do lists from project management tools 212(1)-(n) via the user interfaces of the project management tools along channels 216(1)-(n).

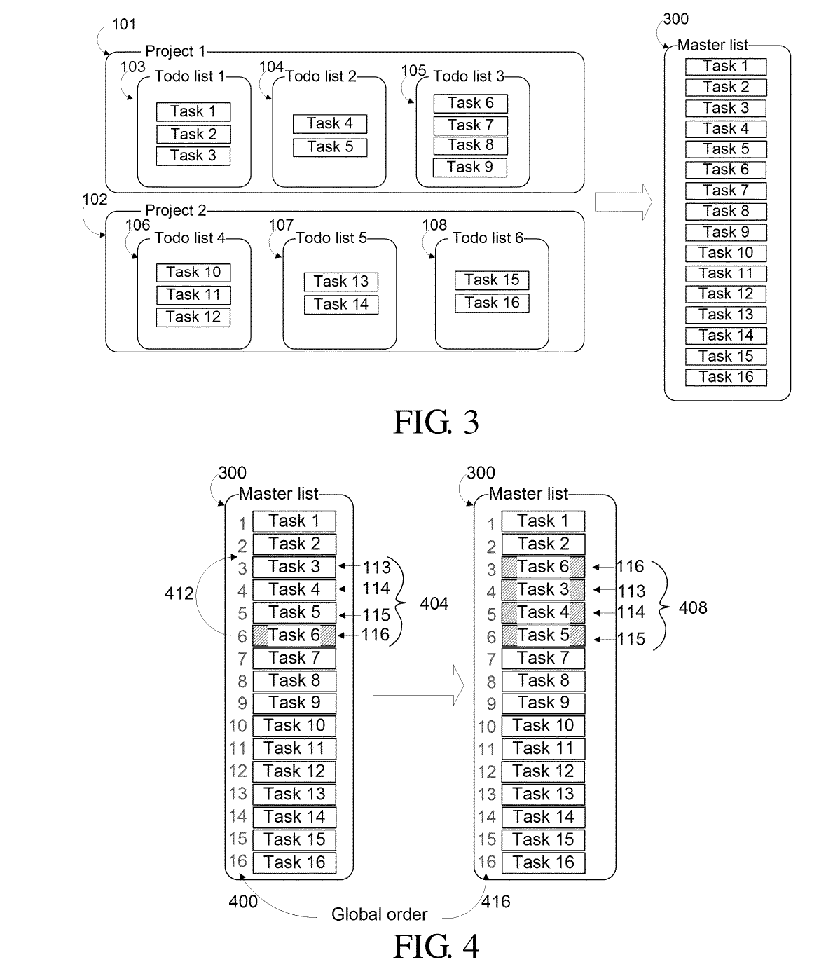

FIG. 3 depicts and exemplary master list 300 that corresponds to master list 204 generated by the master list software aboard master-list server 208 of FIG. 2. In this example, all tasks from all to-do lists, here, to-do lists 103 to 108 and all projects, here, two projects 101 and 102 from conventional project management tool 100 of FIG. 1, are ordered into single master list 300, all of them being visible at once and organized in a list and displayed as schematically shown in FIG. 3.

FIG. 4 illustrates a reordering of master list 300 of FIG. 3 in accordance with a reordering scheme of the present invention. Referring to FIG. 4, the master-list software, such as the software running on master-list server 208 of FIG. 2, assigns all tasks within master list 300 with an initial global order 400 shown on the left-hand side of FIG. 4. Tasks on master list 300 are displayed in an ascending order with respect to their global order 400, in this example from 1 to 16. Before reordering, the portion of master list 300 containing Tasks 3 to 6 is in the state 404 on the left-hand side of FIG. 4, and after reordering, that portion of the master list is in the state 408 on the right-hand side of FIG. 4. When one of Tasks 1 to 16 is being reordered, as represented by arrow 412, from the 6th position to the 3rd position, all tasks between these two positions, i.e., tasks 3, 4, 5 are being reordered as well. A new global order 416 is assigned to the affected tasks, here task 6, 3, 4, 5, as illustrated on the right-hand side of FIG. 4.

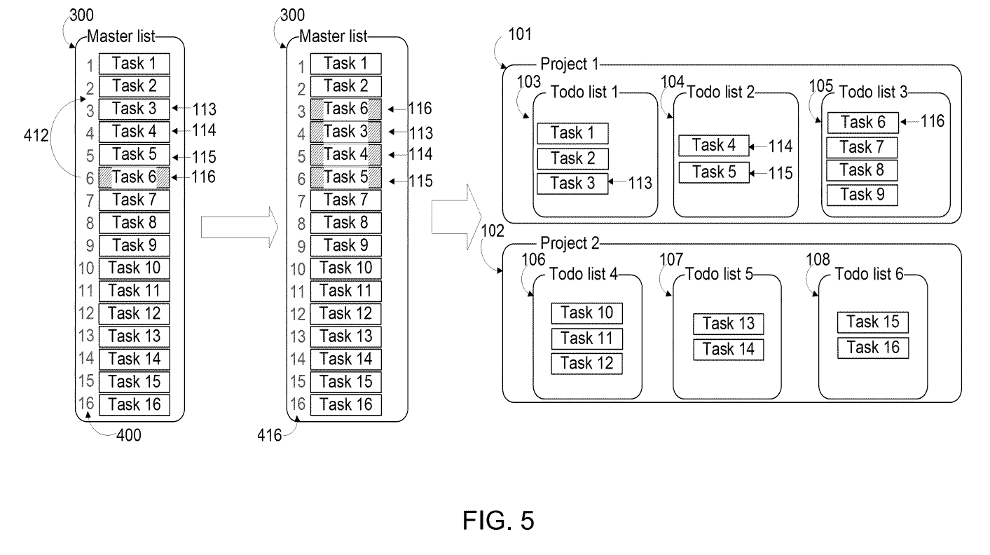

FIG. 5 shows an example of reordering a task within master list 300 (see also FIG. 3) and the reflection of this action back to the original to-do lists 103, 104, 105 (see also FIG. 1). In master list 300, when the task 116 is being reordered from the 6th position to 3rd position, again as illustrated by arrow 412, three other tasks 113, 114, 115 are reordered as well. The changes in global order 400 are the same as illustrated by global order 416 on the right-hand side of FIG. 4. The reordering has to be distributed back to original to-do lists 103, 104, 105, but in this case, no change needs to be made in any of them. Task 116 is originally from to-do list 103, and it was the first task in this list. During the reordering in the master list 300 task 116 shifted the positions of tasks 113 to 115, but these tasks are from different to-do lists, namely task 113 is from to-do list 103, tasks 114 and 115 and from to-do list 104, so the change has not affected the position of these tasks in their respective to-do lists.

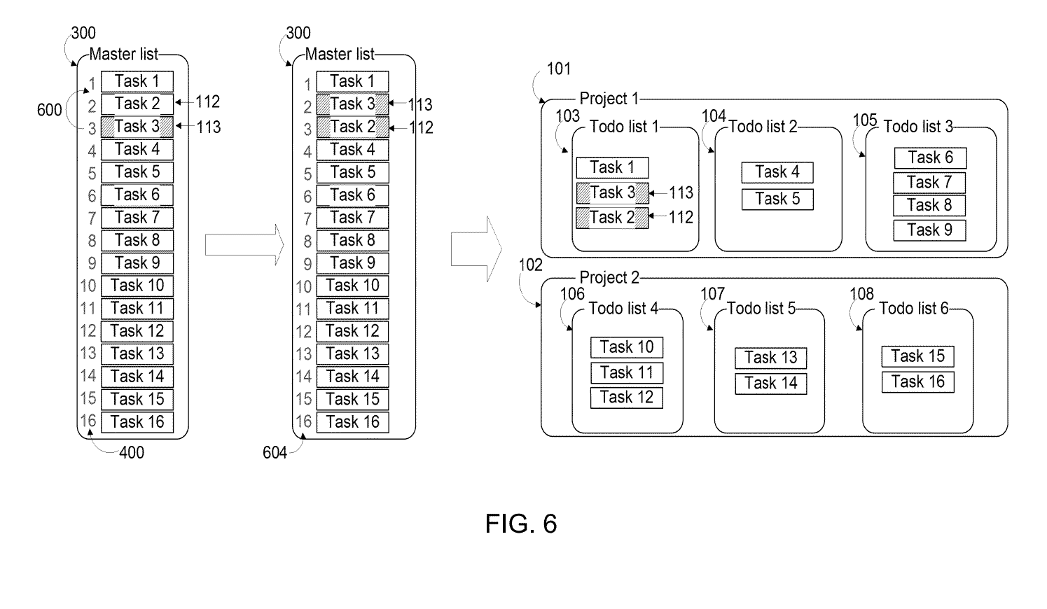

FIG. 6 represents another reordering situation in which a change is needed to be made also in the original to-do list. Referring to FIG. 6, in master list 300 task 113 is being reordered, and inserted above the Task 112. In master list 300, tasks 112 and 113 switch, as represented by arrow 600, their global positions 604, and this new order needs to be distributed into original to-do lists 103 to 108. Both tasks 112, 113 belong to to-do list 102 of project 101, and so their positions within this to-do list are exchanged. No other task from master list 300 has been affected by the change, therefore no other reordering need to be done within original to-do lists 103 to 108.

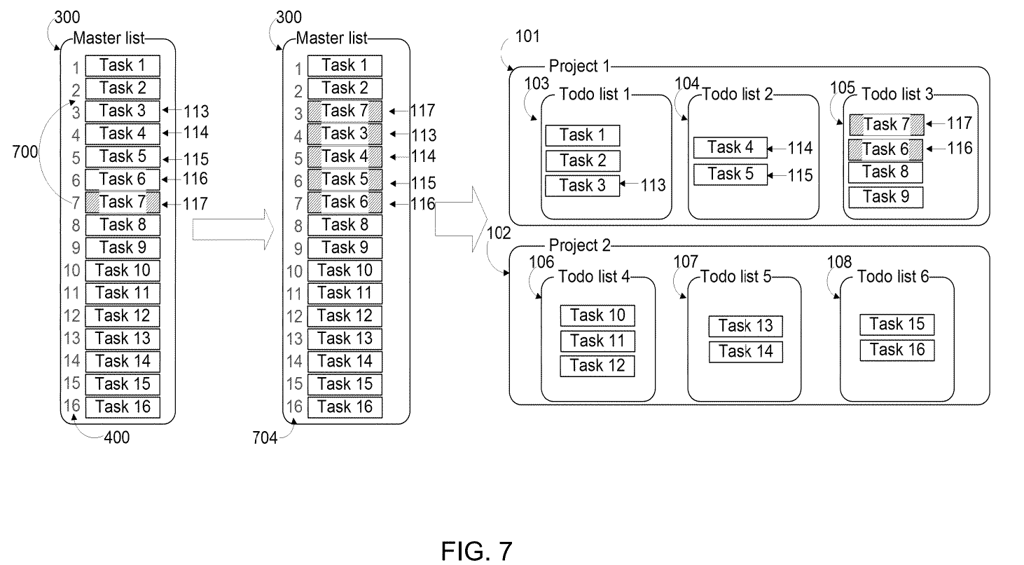

FIG. 7 depicts another example of reordering in master list 300 (see also FIG. 3). Task 117 has been moved, as illustrated by arrow 700, above task 113, and all tasks on positions 3 to 6, i.e., tasks 113 to 116) have been shifted in global order 400 to new global order 704, as shown on the right-hand side of FIG. 7. When new global order 704 has been assigned, the change can be distributed to the original to-do lists 103 to 108 as needed. Although task 113 to 115 have changed their global position, the positions within their original to-do lists 103 and 104 remain untouched. Task 113 from to-do list 103 remains the last one in the list, and tasks 114 and 115 from to-do list 104 remain in the same order as well. Change is made, however, in to-do list 105, wherein the order of tasks 116 and 117 is exchanged.

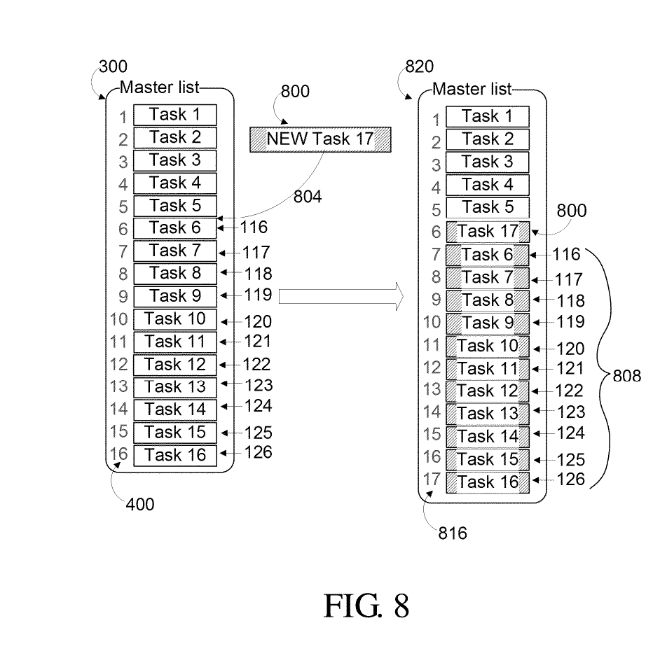

FIG. 8 depicts inserting a new task 800 into global order 400 of the master list 300 (see also FIG. 3). When new task 800 is inserted, as represented by arrow 804) into master list 300 above task 116, all tasks below, i.e., tasks 116 to 126) have to be shifted one position down, as illustrated at 808. New task 800 then gets position 6 in new global order 816 of the enlarged master list 820.

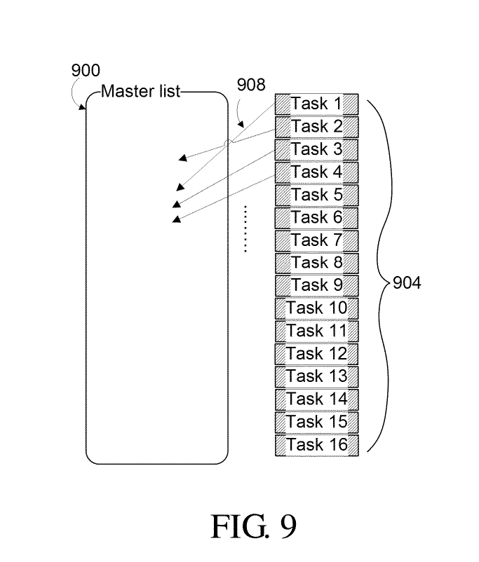

FIG. 9 depicts initial checkout, i.e., when a user starts a new master list 900. At this point, the user has not assigned any tasks to any global positions in master list 900, and all tasks are queued outside the master list, for example, in a queue 904 displayed to the side of a region of a graphical user interface (GUI) wherein the master list is displayed to the user. The global positions for these tasks in queue 904 need to be assigned, as illustrated by arrows 908, by user interaction. For example, the GUI can be designed and configured so that the user can drag and drop the individual tasks from queue 904 to the desired position within master list 900.

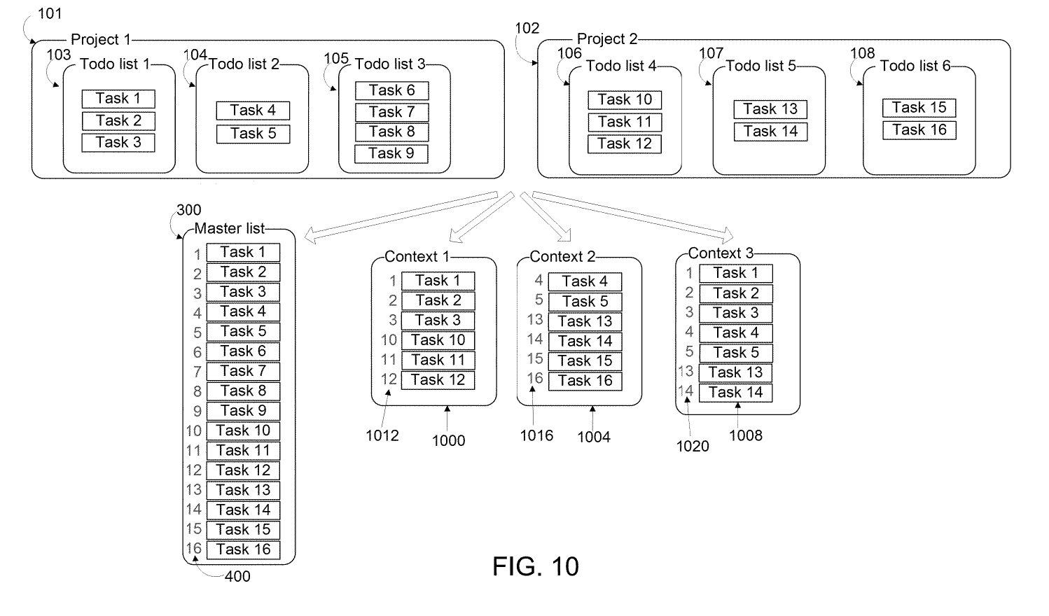

FIG. 10 depicts the principle of contexts. As mentioned above, contexts can be subgroups of to-do lists. Master list 300 is also considered as a context containing all to-do lists from projects 100 and 102 of FIG. 1. Other contexts in this example are contexts 1000, 1004, and 1008. Context 1000 consists of tasks from to-do lists 103 and 106, context 1004 consists of tasks from to-do lists 104, 107, and 108, and context 1008 consists of tasks from to-do lists 103, 104, and 107. While master list 300 has its own global order 400, other contexts use the same positioning, therefore they are not necessarily numbered from 1. Context 1000 has the item ordering 1012 of 1, 2, 3, 10, 11, 12, which is a subgroup of global ordering 400, just as the tasks from this context are a subgroup of master list 300. Similarly, context 1004 has the ordering 1016 set as 4, 5, 13, 14, 15, 16, which corresponds to the ordering of tasks from this context to global ordering 400 in master list 300. Context 1008 has the task ordering 1020 of 1, 2, 3, 4, 5, 13, 14, which corresponds to global ordering 400 from master list 300.

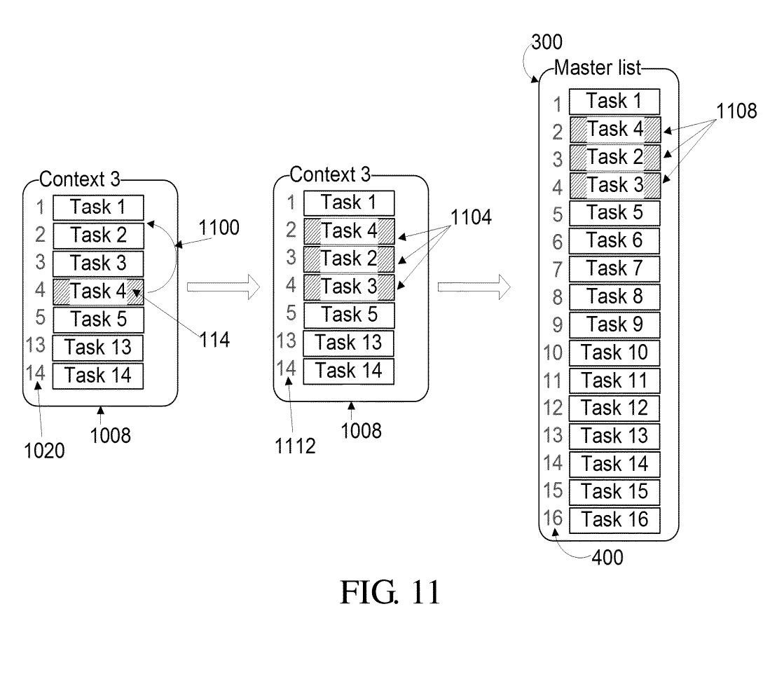

FIG. 11 illustrates reordering within a context. In this example, task 114 is being reordered, as illustrated by arrow 1100, in context 1008, and it is moved above Task 2. Tasks between the old and the new position of task 114 are shifted one position down, and task 114 takes the place of Task 2. Notice that the numbers from the global order 1020 have not changed; context 1008 had the order 1, 2, 3, 4, 5, 13, 14 before the reordering and the same order 1112 after the reordering, as illustrated in the middle list of FIG. 11. The reordering is reflected also into master list 300, where Tasks 4, 2, and 3 are already in their new positions 1108. Global order 400 remains always sorted.

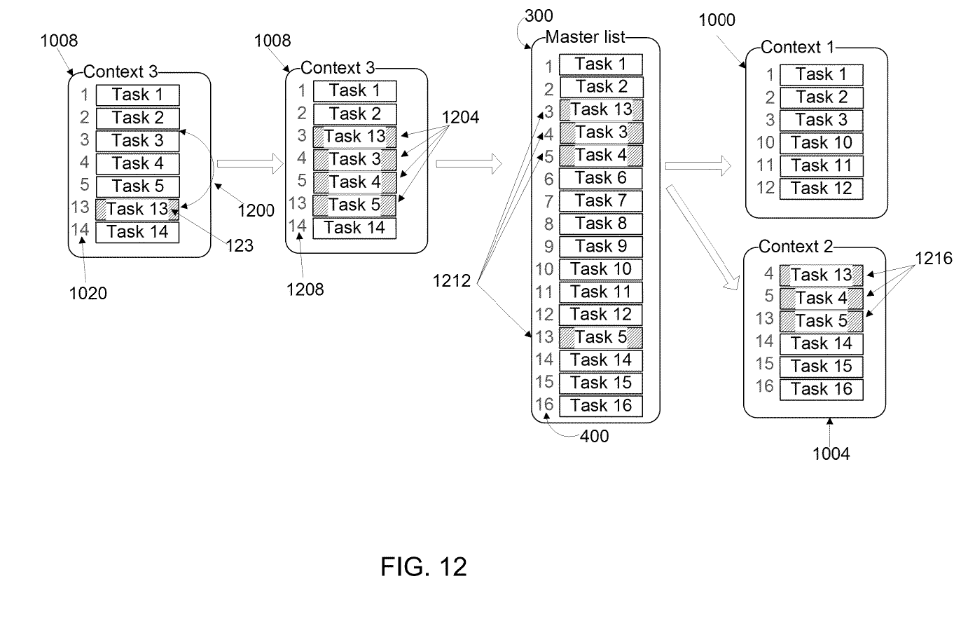

FIG. 12 illustrates another example of reordering tasks in a context. When task 123 is reordered, as illustrated by arrow 1200, in context 1008, the other tasks in this context are reordered, as indicated by change 1204, using the same principle as described in the context of FIG. 11. Change 1204 is reflected as global changes 1212 into master list 300, where Task 13 is inserted at the 3rd position, Task 3 is shifted to the 4th position, Task 4 is shifted to the 5th position, Task 5 is shifted down to the 13th position, which is the original position of Task 13. This change also affects the ordering 1216 in context 1004, while context 1000 remain unchanged.

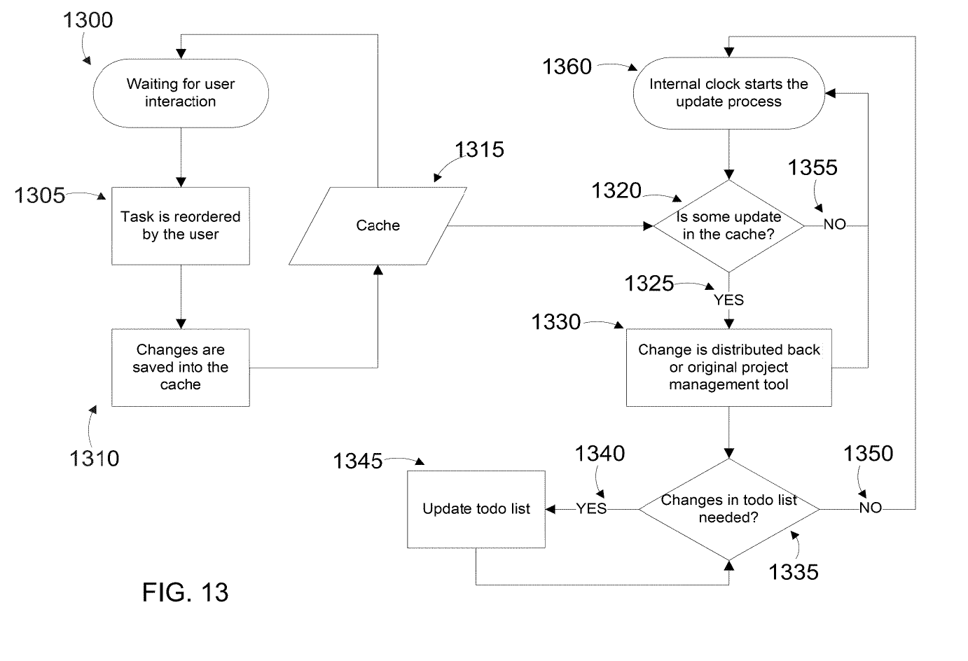

FIG. 13 is a flowchart on how the changes in the order can be distributed back to an original project management tool. At step 1300, the system waits for user interaction, specifically the initiation of reordering. At step 1305 the user reorders a task, and at step 1310 the update is saved into a cache 1315. The system then returns to waiting step 1300 again. At the same time there is internal clock running, and at step 1360 the clock starts an update process that begins at step 1320 with checking cache 1315 at a predefined time interval to determine whether an update is in the cache. If at step 1320 there is nothing in cache, then the process stops and returns 1355 to the waiting mode until the clock again starts the updating process at step 1360. If data are present in the cache 1315, then the process proceeds 1325 to step 1330 at which the change is distributed back to the original project management tool containing the to-do list(s) affected by the change. After that, at step 1335 every to-do lists is checked to determine whether any updates are needed. If update is needed 1340, then the process proceeds to step 1345 at which each to-do list is updated with the new positions. If at step 1335 it is determined that there are no more to-do lists to be updated, the system returns 1350 to the waiting mode until the clock again starts the updating process at step 1360.

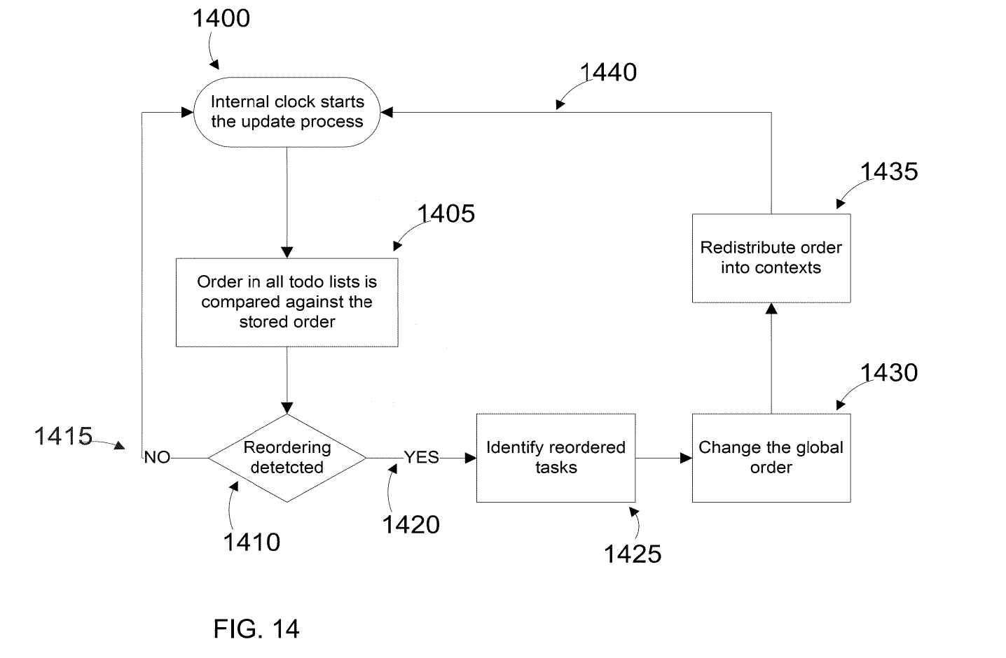

FIG. 14 is a flowchart on how the master-list software can perform, at regular intervals, updates in response to changes in an original project management tool. At step 1400, an internal clock is set to start the regular check into the original project management tool. At step 1405, all to-do lists are grabbed, and the order of tasks in the to-do lists is compared against the order stored in a local database maintained by the master-list system. At step 1410, the software determines whether a reordering has occurred. If not, the process proceeds 1415 to wait and return to step 1400. If a reordering is detected at step 1410, the process proceeds 1420 to step 1425 at which the reordered tasks that need reordering are identified. At step 1430, the change is reflected into the global order of the master list, and at step 1435 the reordering is further distributed into other contexts. When done with the further distribution, the system returns 1440 to the waiting mode and to step 1400.

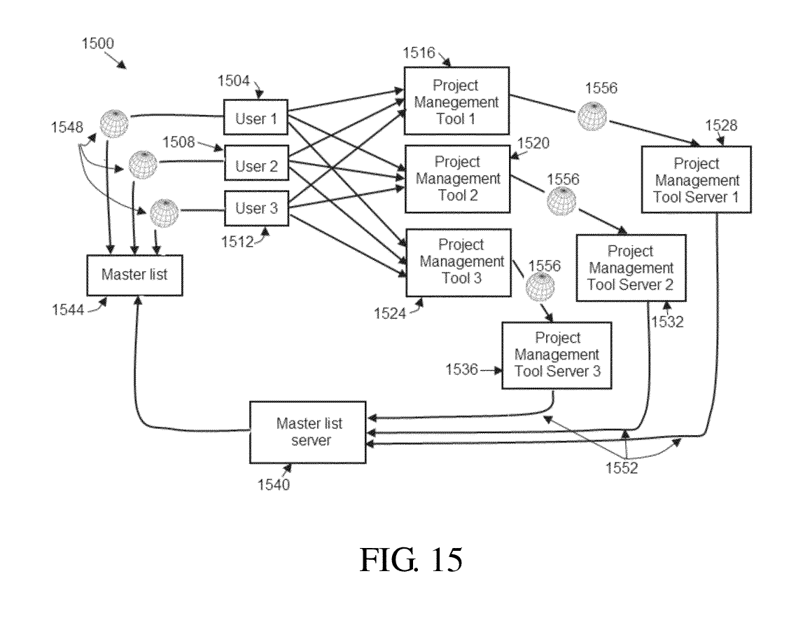

FIG. 15 is a diagram depicting an exemplary computing environment 1500 utilizing master-list software (here, a master-list application 1544) designed and configured in accordance with the present disclosure. In environment 1500, multiple users 1504, 1508, and 1512 can utilize their to-do lists in separate project management tools 1516-1524, which are running on corresponding project management tool servers 1528-1536. Project management tools 1516-1524 are accessed “directly” in this case via wide area network, such as the Internet 1556. In this example, master-list server 1540 communicates with other project management tool servers 1528-1536 via corresponding respective APIs or custom-coded modules 1552. Master-list application 1544 then displays all provided data in one master list to every user 1504-1512 via Internet 1548.

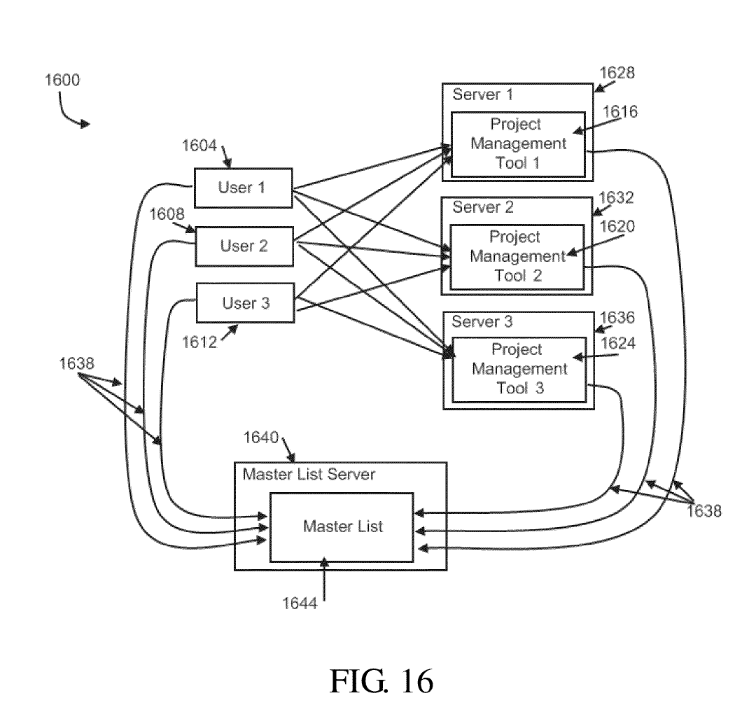

FIG. 16 is a diagram depicting an exemplary computing environment 1600 utilizing master-list software (here, a master-list application 1644) designed and configured in accordance with the present disclosure. In environment 1600, multiple users 1604, 1608, and 1612 can utilize their to-do lists in separate project management tools 1616, 1620, 1624, which are running on corresponding project management tool servers 1628, 1632, 1636. In this example, project management tools 1616, 1620, 1624 are accessed by a direct connection (e.g., via a local area network 1638). Also in this example master-list server 1640 communicates with project management tool servers 1628, 1632, 1636 via corresponding respective APIs or custom-coded modules in the same local network 1638. Master-list application 1644 then displays all provided data in one master list to every user 1604, 1608, 1612 via local network 1638.

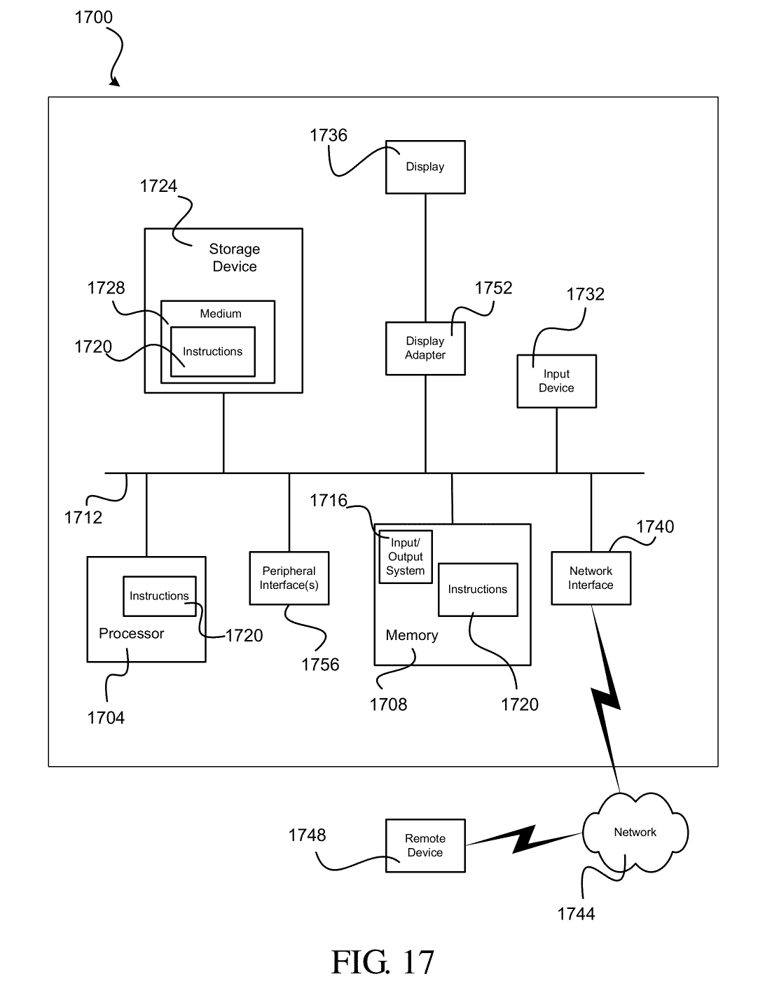

FIG. 17 shows a diagrammatic representation of one embodiment of a computer in the exemplary form of a computer system 1700 that contains a set of instructions for implementing any one or more of the aspects and/or methodologies of the present disclosure, including implementing master-list software depicted in FIGS. 2 to 16 and 18. As an example, computer system 1700 can be used as any one of master-list servers 208, 1520, and 1624 of, respectively, FIGS. 2, 15, and 16. It is contemplated that multiple computing devices may be utilized to implement a specially configured set of instructions for causing the device to perform any one or more of the aspects and/or methodologies of the present disclosure. Computer system 1700 includes a processor 1704 and a memory 1708 that communicate with each other, and with other components, via a bus 1712. Bus 1712 may include any of several types of bus structures including, but not limited to, a memory bus, a memory controller, a peripheral bus, a local bus, and any combinations thereof, using any of a variety of bus architectures.

Memory 1708 may include various components (e.g., machine readable media) including, but not limited to, a random access memory component (e.g., a static RAM “SRAM”, a dynamic RAM “DRAM”, etc.), a read only component, and any combinations thereof. In one example, a basic input/output system 1716 (BIOS), including basic routines that help to transfer information between elements within computer system 1700, such as during start-up, may be stored in memory 1708. Memory 1708 may also include (e.g., stored on one or more machine-readable storage media) instructions (e.g., software) 1720 embodying any one or more of the aspects and/or methodologies of the present disclosure. In another example, memory 1708 may further include any number of program modules including, but not limited to, an operating system, one or more application programs, other program modules, program data, and any combinations thereof.

Computer system 1700 may also include a storage device 1724. Examples of a storage device (e.g., storage device 1724) include, but are not limited to, a hard disk drive for reading from and/or writing to a hard disk, a magnetic disk drive for reading from and/or writing to a removable magnetic disk, an optical disk drive for reading from and/or writing to an optical medium (e.g., a CD, a DVD, etc.), a solid-state memory device, and any combinations thereof. Storage device 1724 may be connected to bus 1712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1724 (or one or more components thereof) may be removably interfaced with computer system 1700 (e.g., via an external port connector (not shown)). Particularly, storage device 1724 and an associated machine-readable storage medium 1728 may provide nonvolatile and/or volatile storage of machine-readable instructions, data structures, program modules, and/or other data for computer system 1700. In one example, software 1720 may reside, completely or partially, within machine-readable storage medium 1728. In another example, software 1720 may reside, completely or partially, within processor 1704. It is noted that the term “machine-readable storage medium” does not include signals present on one or more carrier waves.

Computer system 1700 may also include an input device 1732. In one example, a user of computer system 1700 may enter commands and/or other information into computer system 1700 via input device 1732. Examples of an input device 1732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 1732 may be interfaced to bus 1712 via any of a variety of interfaces (not shown) including, but not limited to, a serial interface, a parallel interface, a game port, a USB interface, a FIREWIRE interface, a direct interface to bus 1712, and any combinations thereof. Input device 1732 may include a touch screen interface that may be a part of or separate from display 1736, discussed further below. Input device 1732 may be utilized as a user selection device for selecting one or more graphical representations in a graphical interface as described above.

A user may also input commands and/or other information to computer system 1700 via storage device 1724 (e.g., a removable disk drive, a flash drive, etc.) and/or network interface device 1740. A network interface device, such as network interface device 1740 may be utilized for connecting computer system 1700 to one or more of a variety of networks, such as network 1744, and one or more remote devices 1748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1744, may employ a wired and/or a wireless mode of communication. In general, any network topology may be used. Information (e.g., data, software 1720, etc.) may be communicated to and/or from computer system 1700 via network interface device 1740.

Computer system 1700 may further include a video display adapter 1752 for communicating a displayable image to a display device, such as display device 1736. Examples of a display device include, but are not limited to, a liquid crystal display (LCD), a cathode ray tube (CRT), a plasma display, a light emitting diode (LED) display, and any combinations thereof. Display adapter 1752 and display device 1736 may be utilized in combination with processor 1704 to provide a graphical representation of a utility resource, a location of a land parcel, and/or a location of an easement to a user. In addition to a display device, a computer system 1700 may include one or more other peripheral output devices including, but not limited to, an audio speaker, a printer, and any combinations thereof. Such peripheral output devices may be connected to bus 1712 via a peripheral interface 1756. Examples of a peripheral interface include, but are not limited to, a serial port, a USB connection, a FIREWIRE connection, a parallel connection, and any combinations thereof.

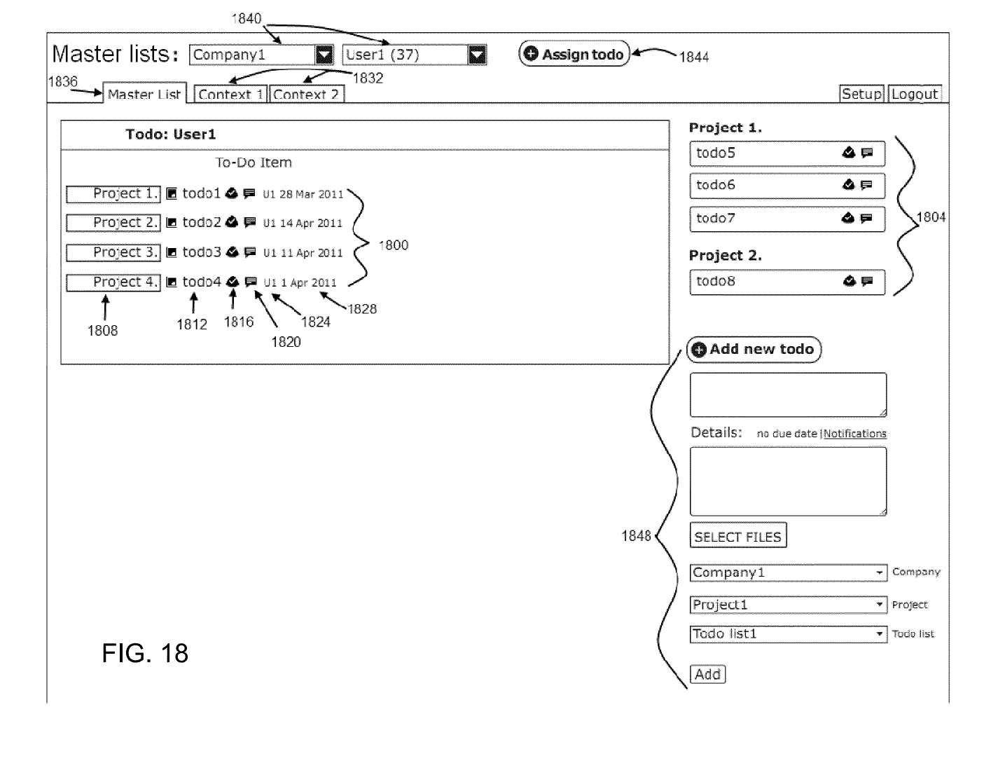

FIG. 18 illustrates an exemplary user interface of a master-list software application designed and configured in accordance with the present disclosure. Tasks 1800, here “todo1” to “todo4,” with already assigned order are located on the left side in a master list 1804. Tasks 1808, here “todo5” to “todo8,” with no assigned order are stacked on the right hand side in a to-be-ordered list 1812, sorted out by projects. In this example, master list 1804 of ordered assigned tasks contains the project name 1816 the corresponding task belongs to, the title 1820 of the task, an icon 1824 for quick access in the original project management tool, an icon 1828 for quick access to the comments for that task, initials 1832 of the user the task is assigned to, and a due date 1836 for that task. Two other contexts have their tabs 1840 located just next to a master-list tab 1844 for ready access to those context. In this example, the user interface also includes a pair of selectors 1848 that allow a user to select a company and a user that allows fast access to other users' master lists. A button 1852 is provided for assigning new tasks to other users. This user interface also includes a form 1856 that allows a user to add new tasks to master list 1804. Those skilled in the art will readily understand how to implement the user interface depicted in FIG. 18, as well as other user interfaces that provide functionality similar to or the same as the depicted user interface or provide other functionality pertinent to the various features of master-list software designed and configured in accordance with the broad features disclosed herein.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of assisting a user in managing to-do items across a plurality of to-do task lists each containing at least one to-do item, comprising:
displaying to-do items from differing ones of the plurality of to-do task lists in an electronically displayed to-be-ordered list;
receiving add-to-master-list input from the user to move ones of the to-do items into an electronically displayed master-list;
in response to said receiving add-to-master-list input, moving to-do items into the electronically displayed master list so that the plurality of to-do items are displayed in a user-desired order; and
assigning, within a database, a global order to the plurality of to-do items as a function of the locations of the plurality of to-do items within the electronically displayed master list.

2. A method according to claim 1, wherein said displaying a plurality of to-do items from differing ones of the plurality of to-do task lists includes displaying a plurality of to-do items from differing electronic project management tools.

3. A method according to claim 1, further comprising updating one or more of the plurality of to-do lists as a function of the global order of the to-do items.

4. A method according to claim 3, wherein said updating includes updating the one or more of the plurality of to-do task lists via at least one application programming interface.

5. A method according to claim 1, further comprising:
receiving, from the user, reorder-master-list input that reorders the to-do items in the electronically displayed master list;
in response to said receiving reorder-master-list input:
electronically displaying a reordered master list; and
updating one or more of the plurality of to-do lists according to the order of the to-do list items in the reordered master list.

6. A method according to claim 5, wherein said updating one or more of the plurality of to-do lists includes updating at least one of the plurality of to-do lists via at least one application programming interface.

7. A method according to claim 1, further comprising electronically displaying a context list containing a subset of the to-do items displayed in the electronically displayed master list.

8. A method according to claim 7, further comprising:
receiving, from the user, reorder-context-list input that reorders the subset of the to-do items in the context list;
in response to said receiving reorder-context list input:
electronically displaying a reordered context list containing the subset of the to-do items; and
reordering, in the master list, only the subset of the to-do items of the reordered context list so as to create a context-reordered master list.

9. A method according to claim 8, further comprising updating ones of the plurality of to-do lists according to the order of the to-do list items in the context-reordered master list.

10. A method according to claim 9, wherein said updating ones of the plurality of to-do lists includes updating at least one of the plurality of to-do lists via at least one application programming interface of an electronic project management tool.

11. A machine-readable storage medium containing machine-executable instructions for performing a method of assisting a user in managing to-do items across a plurality of to-do lists each containing at least one to-do item, said machine-executable instructions comprising:
a first set of machine-executable instructions for displaying to-do items from differing ones of the plurality of to-do lists in an electronically displayed to-be-ordered list;
a second set of machine-executable instructions for receiving add-to-master-list input from the user to move ones of the to-do items into an electronically displayed master-list;
a third set of machine-executable instructions for moving, in response to the receiving of add-to-master-list input, to-do items into the electronically displayed master list so that the plurality of to-do items are displayed in a user-desired order; and
a fourth set of machine-executable instructions for assigning, within a database, a global order to the plurality of to-do items as a function of the locations of the plurality of to-do items within the electronically displayed master list.

12. A machine-readable storage medium according to claim 11, wherein said first set of machine-executable instructions includes machine-executable instructions for displaying a plurality of to-do items from differing electronic project management tools.

13. A machine-readable storage medium according to claim 11, further comprising machine-executable instructions for updating one or more of the plurality of to-do task lists as a function of the global order of the to-do items.

14. A machine-readable storage medium-readable storage medium according to claim 13, wherein said machine-executable instructions for updating includes machine-executable instructions for updating the one or more of the plurality of to-do task lists via at least one application programming interface.

15. A machine-readable storage medium according to claim 11, further comprising:
machine-executable instructions for receiving, from the user, reorder-master-list input that reorders the to-do items in the electronically displayed master list; and
machine-executable instructions for, in response to said receiving reorder-master-list input:
electronically displaying a reordered master list; and
updating ones of the plurality of to-do task lists according to the order of the to-do task list items in the reordered master list.

16. A machine-readable storage medium according to claim 15, wherein said machine-executable instructions for updating ones of the plurality of to-do task lists includes machine-executable instructions for updating at least one of the plurality of to-do task lists via at least one application programming interface.

17. A machine-readable storage medium according to claim 11, further comprising machine-executable instructions for electronically displaying a context list containing a subset of the to-do items displayed in the electronically displayed master list.

18. A machine-readable storage medium according to claim 17, further comprising:
machine-executable instructions for receiving, from the user, reorder-context-list input that reorders the subset of the to-do items in the context list; and
machine-executable instructions for, in response to said receiving reorder-context list input:
electronically displaying a reordered context list containing the subset of the to-do items; and
reordering, in the master list, only the subset of the to-do items of the reordered context list so as to create a context-reordered master list.

19. A machine-readable storage medium according to claim 18, further comprising machine-executable instructions for updating ones of the plurality of to-do task lists according to the order of the to-do task list items in the context-reordered master list.

20. A machine-readable storage medium according to claim 19, wherein said machine-executable instructions for updating ones of the plurality of to-do task lists includes machine-executable instructions for updating at least one of the plurality of to-do task lists via at least one application programming interface of an electronic project management tool.
